(19) United States
(12) Patent Application Publication
(10) Pub. No.: US 2009/0276957 A1
(43) Pub. Date: Nov. 12, 2009

(54) Mat with gel-containing layer and carriers therefor

(76) Inventor: Amanda K. Boitet-Ball, Fort Wayne, IN (US)

Correspondence Address: LAW OFFICES OF BRIAN C. PAULS, 919 SOUTH HARRISON STREET, SUITE 320, FORT WAYNE, IN, 46802, US

(21) Appl. No.: 12/387,705

(22) Filed: May 6, 2009

Related U.S. Application Data
(60) Provisional application No. 61/126,788, filed on May 7, 2008.

(51) Int. Cl. A47G 9/06; G08B 13/14; A45F 3/02; B62B 1/00

(52) U.S. Cl. 5/420; 340/572.1; 224/600; 224/264; 280/47.26

(57) ABSTRACT

A multilayered personal exercise mat having at least one gel-containing layer. The gel-containing layer may include microspheres. The mat may include a flap with reinforced apertures that allow the mat to be suspended from hooks for storage. The mat may also include a security device to limit the loss of such mats from fitness facilities. Other embodiments of the mat may include a skirt for engaging the sides of an aerobic step bench on which the mat has been placed. Carriers for the mats are also disclosed.

### CROSS REFERENCE TO RELATED APPLICATIONS

This application claims priority under 35 U.S.C. 119(e) of U.S. provisional patent application Ser. No. 61/126,788 filed on May 7, 2008 entitled MAT WITH GEL CONTAINING LAYER the disclosure of which is hereby incorporated herein by reference.

### BACKGROUND OF THE INVENTION

1. Field of the Invention

The present invention relates to mats and, more specifically, a floor mat having a gel-containing layer that is suitable for use as a personal exercise mat and carriers for transporting such mats.

2. Description of the Related Art

Floor mats are often used by individuals practicing yoga, pilates and similar forms of exercise. Such exercises are often practiced in group settings where one or more instructors leads a group of individuals through an exercise routine in a large room. The individual participants will often bring their own floor mat or personal exercise mat on which to practice the exercise or use a mat provided by organization hosting the exercise program. While such personal exercise mats are known, an improved floor mat suitable for use as a personal exercise mat and carriers that facilitate the easy transport of such mats remains desirable.

### SUMMARY OF THE INVENTION

The present invention provides a mat having at least one gel-containing layer that is suitable for use as a personal exercise mat and carriers that allow for the convenient transport of such mats together with accessories often used in association with such mats.

The invention comprises, in one form thereof, a personal exercise mat that includes a top layer of material, a bottom layer of material, and a gel layer disposed between the top and bottom layers wherein the gel layer includes a gel material and a plurality of microspheres.

Although dimensions of the mats disclosed herein can vary widely, for most personal exercise applications, the mats will have a length of at least about 36 inches (92.2 cm) and a width of at least about 12 inches (30.7 cm). It will generally be advantageous to keep the bottom layer relatively thin, e.g., a thickness of approximately 0.2 cm, while the top layer and the gel layer will be subject to greater variations, e.g., it will generally be desirable for the top layer to have a thickness within a range of about 0.2 cm to about 0.64 cm and for the gel layer to have a thickness within a range of about 0.32 cm to about 0.48 cm.

The invention comprises, in another form thereof, a personal exercise mat having a top layer of material, a bottom layer of material, a gel layer disposed between the top and bottom layers and a security device permanently affixed to the mat.

The invention comprises, in yet another form thereof, a personal exercise mat and carrier system that includes a plurality of combinations. Each of the combinations including (a) a personal exercise mat having a top and bottom surface and (b) a carrier. The carrier includes first and second oppositely disposed flexible end panels and a flexible bottom panel extending between and secured to the first and second end panels. Opposing flexible side panels extend between and are secured to the first and second end panels with a substantial portion of each of the side panels being formed by a mesh material. The bottom panel is disposed between the side panels. An upper flap is securable to the carrier with first and second substantially parallel zipper assemblies. For each of the plurality of combinations, the top surface of the personal exercise mat and the first and second zipper assemblies have a common color and at least three different colors are used to form the common colors of the plurality of combinations.

The invention comprises, in still another form thereof, a personal exercise mat carrier. The carrier includes a generally L-shaped support structure and a bag. The support structure includes a floor-engaging section and an upright section with at least one rotatable member disposed proximate a lower portion of the upright section. The support structure is self-supporting with the upright section being disposed in a substantially vertical orientation and is supportable on the at least one rotatable member by tilting the upright section. The bag is securable to the support structure and defines an inner volume and has a partition member within the inner volume. The bag further defines an opening providing access to the inner volume. A cap member is repositionable between a closed position and an open position wherein the cap member covers the opening and inhibits access to the inner volume when in the closed position and allows access to the inner volume through the opening when in the open position. The cap member also includes a pouch adapted to hold a towel.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a person using a personal exercise mat.

FIG. 2 is a top view of a mat.

FIG. 3 is a cross sectional view taken along line 3-3 of FIG. 2.

FIG. 4 is an enlarged schematic view of a portion of FIG. 3.

FIG. 5 is a perspective view showing a mat used with an aerobic step bench and having a security feature.

FIG. 6 is a partial cross sectional view of the mat of FIG. 5.

FIG. 7 is a top view of a mat having a skirt for engaging an aerobic step bench.

FIG. 8 is a cross sectional view taken along line 8-8 of FIG. 7.

FIG. 9 is a perspective view of a bag for carrying a rolled mat.

FIG. 10 is a side view of the bag of FIG. 9 having a rolled mat being inserted therein.

FIG. 11 is an exploded view of the bag of FIG. 9.

FIG. 12 is a perspective view of a wheeled carrier for a rolled mat.

FIG. 13 is an exploded view of the wheeled carrier of FIG. 12.

FIG. 14 is a cross sectional view of the wheeled carrier of FIG. 12.

FIG. 15 is a perspective view of an external pocket on the wheeled carrier of FIG. 12.

FIG. 16 is a perspective view of an external bottle holder on the wheeled carrier of FIG. 12.

FIG. 17 is a rear perspective view of a detachable pouch securable to the wheeled carrier of FIG. 12.

FIG. 18 is a perspective view of a sleeve that can be used to secure a rolled mat.

FIG. 19 is a cut-away perspective view of a shoulder pad that can be used with a carrying strap.

FIG. 20 is a perspective view of another carrying device for a rolled mat having the shoulder pad of FIG. 19 mounted thereon.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

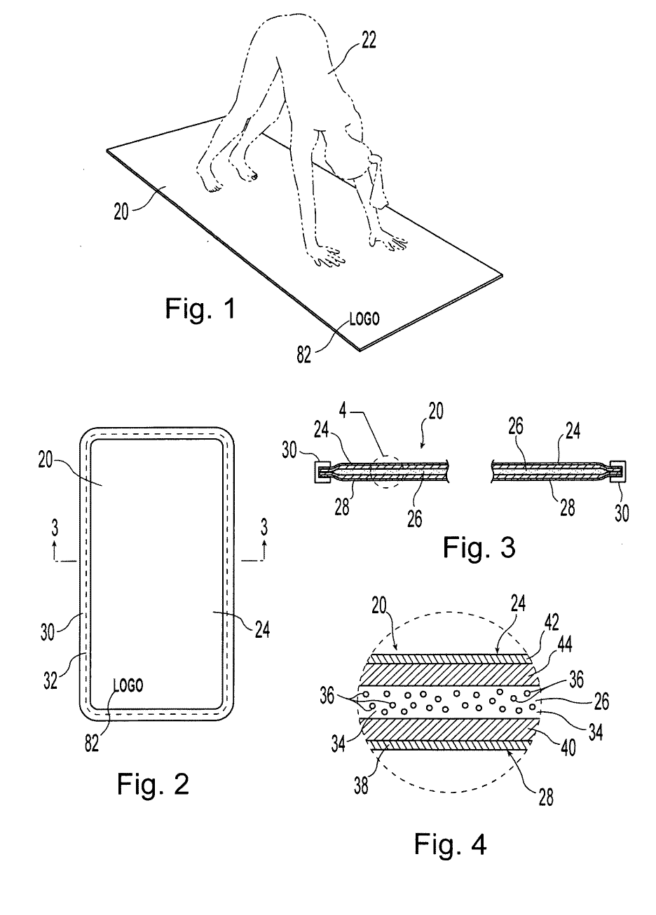

A mat 20 in accordance with the present invention is shown in FIG. 1. Oftentimes, individuals who practice such exercise routines do so in a group setting where a large number of individuals gather together in a single room to practice together. In such situations, it is often desirable for the individuals to bring their own mat to place on the floor and then perform the exercise while on the mat. After the class has been completed, the individual would then take their mat with them when leaving the location of the class. Alternatively, mats might be provided to the individuals for use during the class by the organization or individual hosting the class and the mats would remain at the location of the class for use by other individuals.

Mat 20 has a size that makes it well adapted for use as a personal exercise mat. Conventional yoga mats intended for use by adults will often have a size of 72 inches (184 cm) by 24 inches (61.4 cm) or 68 inches (174 cm) by 24 inches (61.4 cm) while those intended for use by adolescents or children will often have sizes of 60 inches (154 cm) by 24 inches (61.4 cm) or 48 inches (123 cm) by 24 inches (61.4 cm). Such mats 20 may be used by a person 22 who is practicing yoga, pilates or a similar exercise routine. Other sizes and shapes suitable for particular uses, however, may also be employed with a mat 20.

The construction of mat 20 is best understood with reference to FIGS. 2-4. Mat 20 has a top layer 24, a central gel layer 26 and a bottom layer 28. An edging strip 30 extends along the outer perimeter of mat 20 and is folded over both the top layer 24 and bottom layer 28. Stitching 32 is used to secure edging strip 30, top layer 24 and bottom layer 28. In the illustrated embodiment, edging 30 has a width of between 1 inch (2.56 cm) and 1.25 inches (3.2 cm) before it is folded over top and bottom layers 24, 28 into a C-shape and secured along the perimeter of mat 20 and is formed out of a flex weave polyester material. Various other materials, however, may also be used to form edging 30.

Central layer 26 is gel layer that contains both a gel material 34 and resilient gas-filled spheres 36. Gel material 34 is formed by combining a polymeric isocyanate (the “A” component) with a polyether polyol (the “B” component) and microspheres 36. A suitable degasser, e.g., Airex 900 Degasser, is used with the gel to remove air bubbles from the material during mixing. In the illustrated embodiment, microspheres 36 take the form of pre-expanded polyvinyl idine chloride microspheres filled with isobutane but other microspheres, e.g., glass microspheres, may also be employed with the present invention. Microspheres suitable for use with gel layer 26 are commercially available from Akzo Nobel nv headquartered in Amsterdam under the brand name Expancel and microspheres having a product designation 461 DE 40 d 25 are suitable for use with the illustrated embodiment and are dry expanded microspheres having a particle size D(0.5) of 35-55 μm and a true density, kg/m³ of 25±3. The use of such microspheres reduces the density and provides resilient compressibility to gel layer 26.

The relative proportion of polymeric isocyanate (“A”) and polyether polyol (“B”) feedstock materials can be varied to adjust the firmness of gel layer 26 and thereby provide consumers with a choice of mats 20 having varying levels of firmness. For example, by increasing the relative proportions of the A component relative to the B component from a 1:1 ratio to a 60:40 ratio, a firmer gel layer can be obtained. The quantity and properties of spheres 36 can also be varied to provide mats 20 having different properties. The thickness of gel layer 26 can also be varied. For example, mats 20 could be offered with gel layers 26 having a ⅛ inch (0.32 cm) thickness, a 3/16 inch (0.48 cm) thickness or other suitable thicknesses.

Top layer 24 and bottom layer 28 are positioned on opposite sides of gel layer 26 and confine gel layer 26 within the central portion of mat 20. Top and bottom layers 24, 28 may each be formed out of a single sheet of material. Alternatively, top and bottom layers 24, 28 can be formed by multiple sheets of material that together form either top layer 24 or bottom layer 28. In the various embodiments illustrated herein, each of the top and bottom layers 24, 28 has been formed by a combination of two sheets or layers of material.

The illustrated bottom layer 24 has an outermost layer 38 that engages the floor surface when mat 20 is in use and an inner layer 40 that is positioned adjacent gel layer 26. Layer 38 advantageously provides a slip-resistant surface for engaging the floor. In the illustrated embodiment, outermost bottom layer 38 takes the form of a textured mesh skin neoprene layer often referred to as “sharkskin” neoprene and provides a slip-resistant surface. Outermost bottom layer 38, however, may also be formed out of other suitable materials such as a rubber material. Inner bottom layer 40, which is adjacent gel layer 26, is a thin nylon layer in the illustrated embodiment. The total thickness of bottom layer 24, i.e., the combined thickness of layers 38 and 40, is approximately 0.2 cm in the illustrated embodiment but other thicknesses can also be employed.

Top layer 24 includes an outermost layer 42 that forms the top surface of mat 20 and an inner layer 44 that is positioned adjacent gel layer 26. In the illustrated embodiment, top layer 24 is formed out of a combination of a neoprene layer and nylon layer with the outermost layer 42 being a nylon layer and inner layer 44 being a neoprene layer wherein the total thickness of layers 42 and 44 is approximately 0.2 cm. In other embodiments, outermost layer 42 may be a cotton fabric or a polycotton fabric.

In other embodiments, top layer 24 may be a single layer of material formed by a PVC foam that is both positioned adjacent gel layer 26 and forms the top surface of mat 20. For example, a latex-free PVC foam can be used to from top layer 24. The PVC foam or other material used to form top layer 24 may have various thicknesses. For example, a “beginner” mat 20 might be provided with a top layer 24 formed by a PVC foam having a thickness of 0.25 inch (0.64 cm) while an “intermediate” mat 20 might be provided with a top layer 24 formed by a PVC foam having a thickness of ⅛ inch (0.32 cm) and an “advanced” mat 20 might be provided with a top layer 24 formed by a less easily deformable PVC foam or thermoplastic elastomer layer having a thickness of ⅛ inch (0.32 cm). Various other thermoplastic elastomer (TPE) materials can also be used when forming top and bottom layers 24, 28.

Commercially available floor mats can be used to form top layer 24 and/or bottom layer 28 when manufacturing mat 20. For example, top layer 24 could be formed using yoga mats obtained from Nu-Source Inc., having a place of business at 701 Seneca Street, Suite 400, Buffalo, N.Y. 14210, such as the mats sold under the product names Europa Mat and Terra Pure Mat which is formed out of a recyclable thermoplastic elastomer closed cell foam that does not contain any heavy metals, PVC (polyvinyl chloride), latex or rubber. Bottom layer 28 could also be formed out of such mats or other suitable floor or yoga mat.

As mentioned above, mats 20 can be adapted to suit the preferences of beginners and advanced practioners. Providing the “beginner” mat with a greater thickness of foam on the top layer of the mat allows the person using the mat to sink more deeply into the mat and thereby more easily exert lateral forces against the mat and, thus, more easily maintain their balance while on the mat. Varying other properties of the mat layers, e.g., modulus of elasticity, to control the “firmness” of the mat will also determine how much the mat will deform with more advanced practitioners generally preferring firmer mats. In this regard, it is noted that varying the properties of spheres 36 or the number of spheres 36 per cubic centimeter of gel material are also among the several ways that the firmness of the resulting mats 20 can be varied.

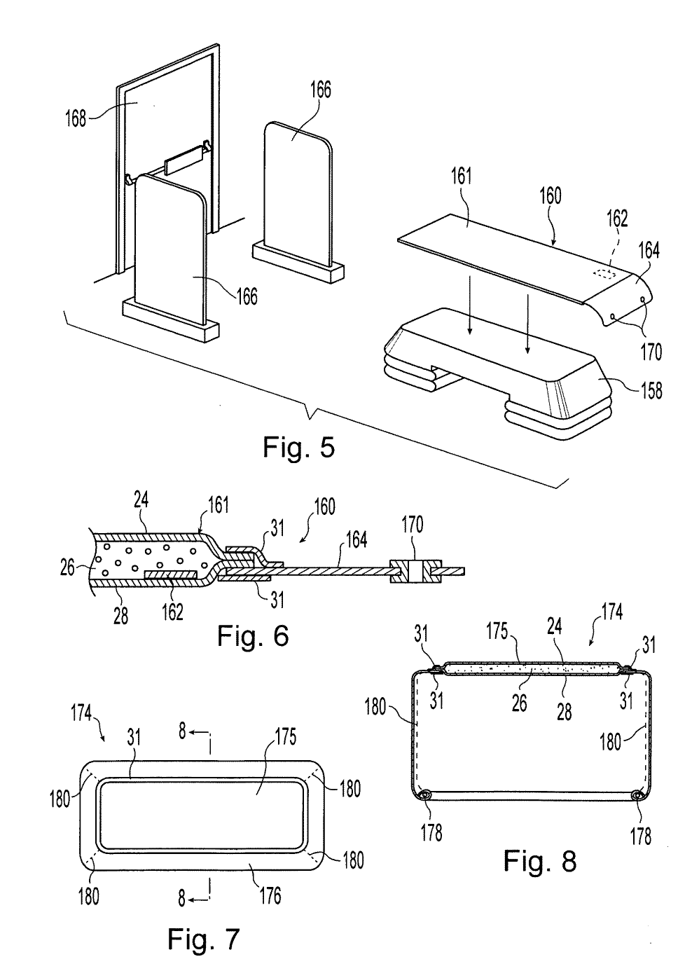

Two different embodiments of personal exercise mats in accordance with the present invention that are adapted for use with aerobic step benches are illustrated in FIGS. 5-8. Turning first to mat 160 depicted in FIGS. 5 and 6, mat 160 has a general construction similar to mat 20. Mat 160 includes a top layer 24, a central gel-layer 26, a bottom layer 28 and an edging strip that are manufactured in the manner discussed above with reference to mat 20. As discussed below, mat 160 differs from mat 20 by having dimensions which adapt mat 160 for placement on a conventional aerobic step bench 158 and by including a security device 162 and support flap 164.

Many fitness facilities have aerobic step benches 158 that can used when performing various exercises. While the precise dimensions of such step benches may vary, a mat having a width of approximately 14 inches (35.6 cm) and a length of approximately 40 inches (101.6 cm) will be well adapted for use with a significant number of such step benches. In the illustrated embodiment, the mat portion 161 of mat 160 (i.e., mat 160 excluding flap 164), has a width of approximately 14 inches (35.6 cm) and a length of approximately 40 inches (101.6 cm). By placing a mat 160 on the top surface of bench 158, mat 160 will provide step bench 158 with an upper padded surface as can be understood with reference to FIG. 5. For many of the exercises that can be performed using a step bench 158, the provision of such a padded surface on bench 158 will enhance the user's comfort when using the step bench 158.

By providing mat 160 with a security device 162 that is permanently affixed to mat 160, fitness facilities which have step benches 158 can provide the users of the facility with access to mats 160 without fearing that the users will take mats 160 with them when they leave the fitness facility. Security device 162 works in cooperation with pedestal sensors 166. Sensors 166 generate an alarm if a person attempts to remove mat 160 by walking between sensors 166 to reach exit doorway 168. In the disclosed embodiment, security device 162 is positioned within the central gel layer 26 between top layer 24 and bottom layer 28.

FIG. 6 provides a schematic cross sectional view of mat 160. As can be seen in FIG. 6, security device 162 is secured adjacent bottom layer 28 in the illustrated embodiment. Device 162 can be secured to bottom layer 26 with an adhesive or simply be trapped in place between the layers of mat 160. When secured to the upper surface of bottom layer 28, gel layer 26 and top layer 24 will both be positioned above security device 162 and the user of mat 160 will be less likely to feel the presence of security device 162 when using mat 160. Security device 162 can also be permanently affixed to mat 160 in other locations and employing other means of securement.

Security device 162 and pedestal sensors 166 form what is commonly referred to as an electronic article surveillance (“EAS”) system. Such systems are often used by retail stores to detect and prevent shoplifting and by libraries to prevent the loss or theft of books. A variety of different EAS and similar security systems are commercially available and can be used with mats 160. For example, security device 162 can take the form of an RFID (radio frequency identification) tag. There are two main types of RFID tags, active and passive. Active RFID tags include a battery while passive RFID tags do not include a battery and are generally less expensive than active RFID tags. For many fitness facility applications, passive RFID tags will provide an adequate security device 162. Suitable security devices 162 and pedestal sensors 166 are commercially available from ADT Security Services, Inc. having a headquarters located at 1 Town Center Rd., Boca Raton, Fla. 33486. By utilizing security device 162, the fitness facility can avoid having users “check-out” individual mats at a central desk and thereby reduce the amount of labor required to operate the fitness facility without dramatically increasing the loss of mats 160.

Mat 160 also includes a flexible flap 164 extending from one end of mat 160. Flap 164 includes two metal eyelets that form reinforced apertures 170. When not in use, mats 160 can be conveniently stored by suspending mats 160 from hooks or similar projections on a wall. Polyester and nylon fabrics as well as other flexible materials having an adequate strength can be used to form flap 164. The illustrated flap 164 is secured to the top and bottom layers 24, 28 of mat 160 with stitching in the illustrated embodiment and has one edge positioned beneath edging strip 31. The edging strip 31 used with mat 160 is similar to edging strip 30 discussed above with reference to mat 20. Edging strip 31 differs, however, where flap 164 is joined to mat portion 161 and two edging strips 31 are used on opposite sides of the mat instead using a single strip 30 folded over the edge of the mat. The openings in flaps 164 for receiving support hooks are advantageously reinforced to prevent damage to flaps 164. While metal eyelets 170 are utilized in the illustrated embodiment, the apertures in flaps 164 can be also be reinforced using other suitable means.

FIGS. 7 and 8 illustrate another mat 174 that is adapted for use with a step bench 158. Mat 174 includes a central mat 175 that has a general construction similar to mat 20 with a top layer 24, a central gel-layer 26, and a bottom layer 28 that are manufactured in the manner discussed above with reference to mat 20. As discussed below, mat 174 differs from mat 20 by having dimensions which adapt mat 174 for placement on a conventional aerobic step bench 158 and by including a skirt that encircles and engages the sides of step bench 158. Central mat portion 175 has a width of approximately 14 inches (35.6 cm) and a length of approximately 40 inches (101.6 cm) but can also be manufactured in alternative dimensions to fit differently sized aerobic step benches.

A material skirt 176 is attached to the outer perimeter of central mat portion 175 and extends downwardly therefrom. An elastic band 178 is secured to skirt 176 along the full perimeter of the lower edge of skirt 176. Skirt 176 has seams 180 at the corners of mat 174 and is “fitted” to conform to engage a supporting object having the same general shape of central mat 175. Elastic band 178 at the lower edge of skirt 176 is elastically stretchable and will tightly engage step bench 158 when mat 174 is positioned thereon. In the illustrated embodiment, skirt 176 is formed out of an elastically stretchable fabric such as Columbia Sportswear Company's Omni-Tech® stretchable Lazer fabric. Thus, in the illustrated embodiment, both the material forming skirt 176 and the elastic band 178 attached near the lower edge of skirt 176 form elastically stretchable portions of the skirt that will engage the sides of step bench 158 when mat 174 is placed on bench 158. Edging strips 31 are used to cover and reinforce the location where skirt 176 is joined to central mat 175. Alternative embodiments of skirt 176 could employ a non-elastically stretchable fabric and rely solely on elastic band 178 for engaging the sides of step bench 158 or use an elastically stretchable fabric to form skirt 176 and omit the lower elastic band 178 and rely solely on the elastic properties of the fabric itself to engage the sides of step bench 158.

It is noted, that both mats 160 and 174 have a bottom layer 28 similar to mat 20 with an inner nylon layer and an outermost textured mesh skin neoprene layer that forms non-slip exterior surface engageable with the top surface of step bench 158. It is the engagement of this non-slip surface with bench 158 that prevents mats 160, 174 from slipping on the upper surface of bench 158. The primary purpose of skirt 176 is an aesthetic purpose. If a firmer engagement with step bench 158 is desired, velcro straps extending from opposed sides of the mats can be used to wrap around bench 158 and secure the mats to bench 158.

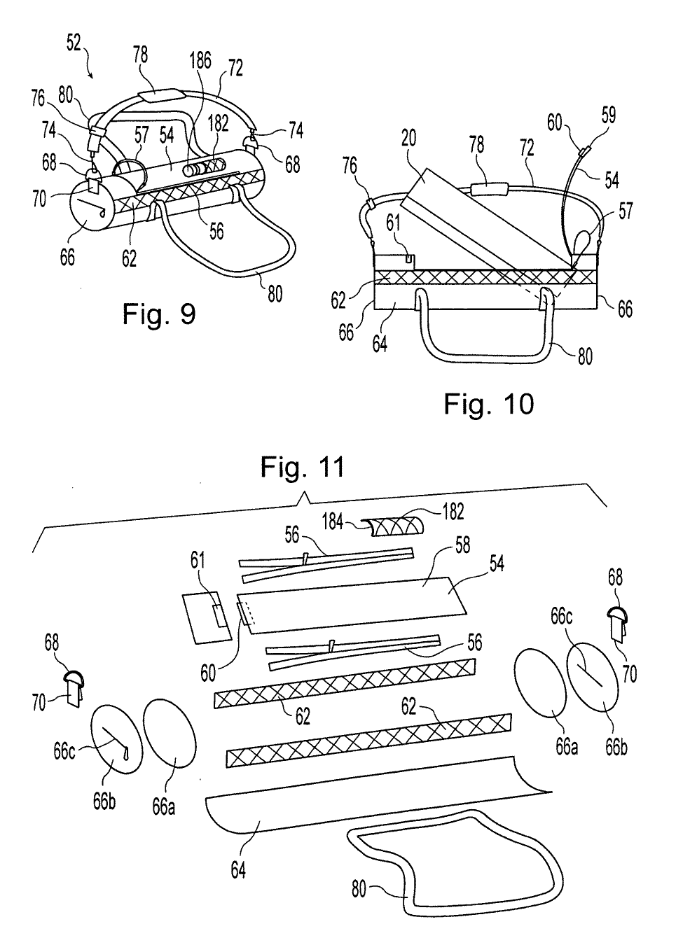

FIGS. 9-11 illustrate a mat carrier 52 that can be used to easily transport a personal exercise mat or other objects. Carrier 52 is sized to receive a rolled mat 20 and the insertion of a rolled mat 20 into carrier 52 is illustrated in FIG. 10. As can be seen in FIG. 10, carrier 52 includes a cover flap 54 that is shown in an open condition in FIG. 10 thereby allowing rolled mat 20 to be inserted in carrier 52. After inserting mat 20 into carrier 52, flap 54 is closed using two parallel zippers 56. A strap 57 connects the two hooks of the two parallel zipper assemblies 56 and allows for the convenient simultaneous operation of both zippers 56 with a single hand. The zipper assemblies 56 have a conventional construction, with the zipper hooks being secured to wedges which act to engage and disengage the two opposing tracks of each of the zipper assemblies 56. Flap 54 is formed by a portion of upper fabric panel 58 that lies between zippers 56. The free edge 59 of flap 54 is secured to a stationary portion of panel 58 through cooperating hook and loop fasteners 60, 61.

The side panels 62 of carrier 52 are open mesh panels that allow for the free passage of air through side panels 62. The free passage of air through panels 62 facilitates the evaporation of moisture on items located within carrier 52 and on the interior surfaces of carrier 52. Mesh side panels 62 may be formed out of 7 or 10 ounce vinyl coated mesh or other suitable material.

As best understood with reference to FIG. 11, carrier 52 also includes a bottom fabric panel 64 and two substantially circular end panels 66. Oppositely disposed end panels 66 have an exterior pocket and are formed by securing an internal panel 66a to an external panel 66b wherein the external panels 66b have a zippered opening 66c. Top panel 58, including flap portion 54, bottom panel 64 and end panels 66a, 66b may be advantageously formed out of a 400-1000 Denier textured nylon or other suitable material. For example, such panels can be formed using a 600 Denier material commercially available under the brand name MagnaTuff Plus or a 500 Denier nylon material commercially available under the brand name Cordura. These same materials can also be used to manufacture bag 112 discussed below. Cotton fabrics, e.g., organic cotton fabrics, such as 7 or 10 oz. duck or twill cotton fabrics and a wide variety of other suitable fabrics may also be used in the manufacture of carrier 52 and bag 112. Panels 58, 62, 64 and 66 are joined together using stitching or other suitable means. Carrier 52 may be offered in various sizes, however, it is anticipated that a single size carrier 52 will work with a large number of different personal exercise mats.

D-rings 68 are secured to end panels 66 using fabric flaps 70. A shoulder strap 72 is removeably secured to D-rings 68 using conventional snaphooks or swivel snaphooks 74. A conventional 1.5 to 2 inch wide three-posted buckle 76 or “tri-glide” is used to adjust the length of the shoulder strap 72 which is formed out of 1 to 1.5 inch wide webbing. A shoulder strap pad 78 is also located on shoulder strap 72. A cut-away perspective view of shoulder strap pad 78 is shown in FIG. 19 and discussed in greater detail below. Rubber and foam padded shoulder pads are also commercially available and could be used with strap 72. Webbing in the form of a large loop is also secured to carrier 52 with stitching to form handles 80. Mesh panel 182 is secured to the outer surface of flap 54 to form a water bottle holder. Mesh panel 182 is secured along three of its four edges with the fourth edge having an elastic band 184 secured thereto. Water bottles 186 and similar beverage containers can secured on the exterior of carrier 52 by sliding bottle 186 underneath elastic band 184 and between mesh panel 182 and flap 54. Carrier 52 does not include any rigid members and can be easily reduced to a small size when it is empty.

When yoga or other exercise classes are held and a number of individuals bring their own exercise mats, it is quite common for the individuals to remove their mats from carriers and place the mat carriers along the edge of the room where the exercise class takes place. When the class is quite large, the possibility of more than one individual purchasing similar mats and carriers increases. This can lead to confusion when the class is over and the individuals try to relocate their carriers for their mats. One way of reducing this possible source of confusion is by manufacturing the mats 20 and carriers 52 in different colors so that the different mats and carriers can be distinguished by color. Utilizing different colored components, however, increases the number of different inventory components necessary to manufacture mats 20 and carriers 52 which can lead to an increase in manufacturing costs.

The disclosed mats 20 and carriers 52 can be manufactured to provide a variety of color coded “pairs” with only a minimal number of differently colored parts. For example, mats 20 can be manufactured with the outermost top layer 42 having at least three different colors. Carriers 52 can be manufactured with the zipper assemblies 56 having at least three different colors that correspond to the different colors of layer 42. Individuals can then purchase a mat 20 with a carrier 52 wherein the mat 20 has an outermost layer 42 having the same color as zipper assemblies 56. For example, a manufacturer or retailer could sell a mat 20 combined with a carrier 52 wherein the mat 20 and carrier 52 having an outermost layer 42 and zipper assemblies 56 with matching colors and the consumer has a choice of at least three different colors (e.g., red, pink or blue) for the outermost layer 42 and zipper assemblies 56. For carriers 52 having exterior pockets in the end panels 66, the color of zippered openings 66c can vary with zipper assemblies 56.

By color coding the mats 20 and carriers 52 in this manner, a person who has purchased a “blue” mat with a carrier 52 having “blue” zippers will be find it easier to locate their carrier after completing the exercise class. Many individuals will also find the appearance of such carriers and mats to be aesthetically pleasing.

It will often be desirable to apply logos to mats 20, 160, 174; carriers 52 and wheeled carriers 110 which are discussed below. Such logos 82 can be formed using various means including rayon thread stitching. It is also noted that while logos 82 can be placed at various locations on mat 20, by placing a logo 82 near one end of mat 20 as depicted in both FIGS. 1 and 2, the logo 82 will remain visible when mat 20 has been rolled and can be positioned so that it is visible through one of mesh side panels 62.

As can be seen in FIG. 19, shoulder strap pad 78 includes two outer layers 188, 190 and a central gel layer 192. Outer layer 188 will engage the shoulder of the user and is similar in construction to top layer 24 of mat 20. Outer layer 190 will engage the shoulder strap and is similar in construction to bottom layer 28 of mat 20. It will generally be desirable that pad 78 does not slip on the shoulder strap when in use and providing outer layer 190 with an anti-slip surface is advantageous. Gel layer 192 is formed out of the same materials as gel layer 26 and although the illustrated gel layer 192 includes microspheres 36, alternative embodiments can utilize a gel layer without microspheres 36. Edging 194 extends along the outer edges of the shoulder pad 78. Flaps 196 extend inward from edging 194 and are used to secure pads 78 to a shoulder strap. One of the flaps 196 has a panel of hook fasteners 198 while the other flap 196 has a panel of loop fasteners 200 to secure flaps 196 together and thereby secure pad 78 on a shoulder strap.

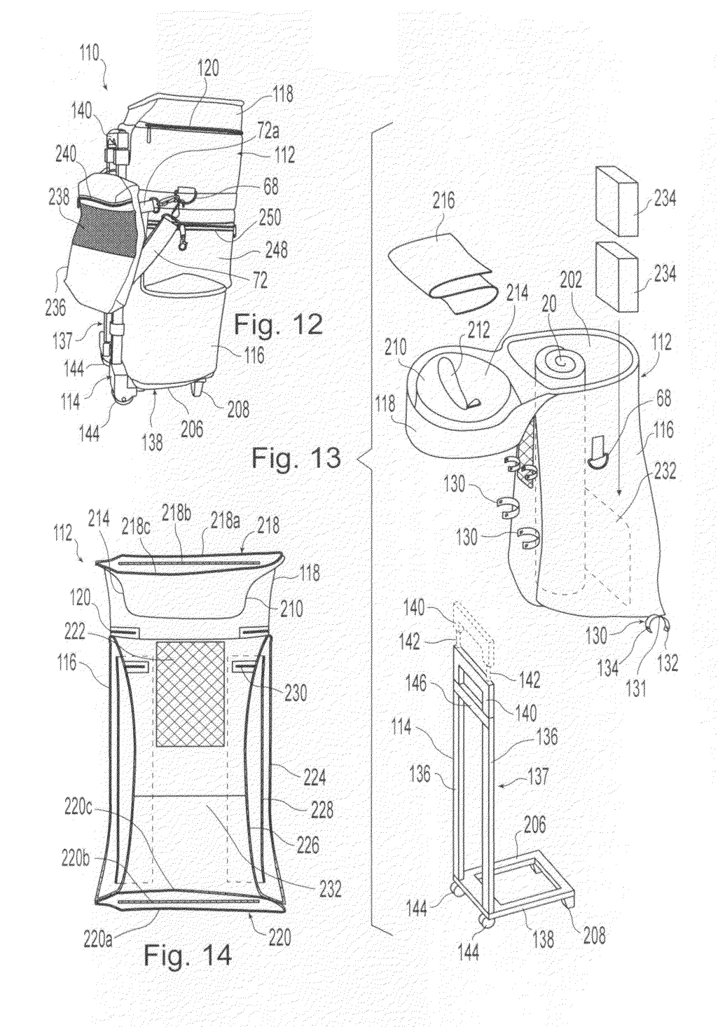

Another carrier 110 for a rolled mat 20 is depicted in FIGS. 12-14. Carrier 110 includes a generally cylindrical bag 112 that is mounted on a generally L-shaped wheeled support structure 114. Bag 112 has a lower portion 116 and an openable cap member 118. Cap 118 is secured with a zipper 120 and has an open position (FIG. 13) and a closed position (FIGS. 12 and 14). In the open position, cap 118 permits access to inner volume 202 of bag 112 through bag opening 204. The bottom of bag 112 sits on a ground engaging section 138 of support structure 114 when bag 112 is attached to support structure 114. Fabric straps 130 are sewn to bag 112 at a central portion 131 of straps 130 and have hook 132 and loop 134 panels secured near their opposite ends to secure bag 112 to support structure 114. Four straps 130 are fastened about the vertical members 136 of upright section 137 of support structure 114 and another strap 130 is located at the front lower edge of bag 112 and is fastened to ground engaging section 138. The disengagement of hook and loop fasteners 132, 134 allows bag 112 to be removed from support structure 114. While the illustrated carrier 110 has a bag 112 that is detachable from support structure 114, alternative embodiments could employ bags that are permanently attached to support structure 114.

Support structure 114 is similar to that used with conventional luggage. A handle 140 is mounted on two post members 142 which are slidably mounted in vertical members 136 whereby handle 140 can be raised and lowered relative to support structure 114. FIG. 13 shows handle 140 in solid lines in its lowered position and shows handle 140 in dashed lines in its raised position. An upper cross piece 146 enhances the structural integrity of support structure 114.

Rotatable members such as wheels 144 are mounted on support structure 114 proximate the lower end of upright section 137 and are attached to ground engaging section 138. Ground engaging section 138 includes a support panel 206 and projecting feet 208 that directly engage the ground surface. When wheels 144 and feet 208 are engaged with a substantially level ground surface the support structure 114 (along with bag 112 attached thereto) is self-supporting with upright section 137 being disposed in a substantially vertical orientation. FIG. 12 illustrates carrier 110 in a self-supporting position. When moving carrier 110, it will generally be most convenient to raise handle 140, tilt carrier 110 so that it is supported solely by wheels 144 and then pull carrier 110 by handle 140 so that it rolls along the floor or ground surface on wheels 144.

As best seen in FIGS. 13 and 14, cap member 118 includes a pouch 210 having a zippered opening 212 located on the interior side of cap 118. Pouch 210 is formed by a sheet of suitable fabric 214 that is fitted to form an internal enclosure within cap 118. Pouch 210 has a size that allows it to receive a standard sized bath towel 216 as schematically depicted in FIG. 13. In addition to a towel 216, a yoga strap (not shown) and other small items may also be placed in pouch 210. While the illustrated pouch 210 has an opening 212 located on the interior of cap member 118 which is not accessible when cap member 118 is in its closed position, alternative embodiments could employ a pouch having an external opening that is accessible when cap member 118 is in its closed position.

The top and bottom end panels 218, 220 of bag 112 each have a three part construction with an outer fabric layer 218a, 220a, an inner fabric layer 218c, 220c and a stiffening member 218b, 220b, disposed between the inner and outer fabric layers. The inner and outer fabric layers are sewn together along their outer perimeter to secure the stiffening members 218b, 220b in place. The stiffening members 218b, 220b are thin, rigid planar members that are formed out of any suitable lightweight rigid material such as a rigid plastic material. The stiffening members 218b, 220b help to maintain the shape of bag 112 and have a generally circular shape with one straight edge located proximate support structure 114.

The flexible fabric used to form bag 112 is mostly a solid fabric such as a 600 Denier polyester, however, bag 112 also includes a mesh panel 222, e.g., a 7 or 10 ounce vinyl coated mesh or other suitable material, that promotes air flow between inner volume 202 of bag 112 and the surrounding ambient environment. This air flow helps to promote the evaporation of moisture on a mat 20 and other objects that are located within bag 212.

The lower body 116 of bag 112 has a generally cylindrical shape and a three layered wall. The three layers include an exterior fabric layer 224, an internal fabric layer 226 and an internal foam layer 228. The internal fabric layer 226 includes a zipper 230 that extends parallel with cap zipper 120 about the majority of the circumference of bag 112. Zipper 230 provides access to the space between fabric layers 224 and 226. Foam layer 228 is inserted through the opening of zipper 230 and provides a supporting structure for the body of bag 112. Foam layer 228 is a flexible foam such as a flexible polyurethane foam having a thickness of approximately 0.25 inch (0.64 cm). While foam layer 228 provides some supporting structure to bag 112, it still allows the overall shape of bag 112 to adjust when bag 112 is subjected to internal and external pressures. Foam layer 228 does provide enough structure to prevent the total collapse of bag 112 when cap 118 is in its open position and by retaining lower section 116 in a substantially cylindrical shape when cap 118 is open, foam insert 228 facilitates the placement of rolled mat 20 and other objects into bag 112.

Bag 112 also includes an internal fabric panel 232 that forms a partition within inner volume 22 separating inner volume 212 into two compartments. As can be seen in FIG. 13, a rolled yoga mat 20 can be positioned on one side of partition 232 while yoga blocks 234 and other objects, such as yoga shoes, can be stored on the opposite side of partition 232.

The exterior of bag 112 also includes useful features. Two D-rings 68 are attached with webbing to opposite sides of cylindrical body 116. A shoulder strap 72 can be attached to D-rings 68 and thereby allows bag 112 to be easily carried when it is detached from support structure 114. A second smaller strap 72a having the same construction as shoulder strap 72 but utilizing a smaller web of material and omitting the shoulder strap pad is also shown attached to bag 112 in FIG. 12. Strap 72a is used to secure a detachable pouch 236 to bag 112.

Detachable pouch 236 is shown attached to carrier 110 in FIG. 12 and also in FIG. 17. As can be seen in FIG. 12, pouch 236 has a mesh panel 238 to promote the flow of air between the interior and exterior of pouch 236. A zipper 240 is used to open and close the access opening of pouch 236. As best seen in FIG. 17, a strap 242 extends from the upper edge of pouch 236 and can be used to support pouch on support structure 114. Strap 242 has two snap connectors 244 that can be secured together after strap 242 has been wrapped about cross member 146 of support structure 114 to thereby suspend pouch 236 from support structure 114. The backside of pouch 236 has two straps 246 attached thereto. Straps 246 are similar to belt loops and strap 72a is threaded between straps 246 and the back panel of pouch 236 to attach pouch 236 to bag 112. Thus, pouch 236 can be attached to support structure 114 and/or bag 112 providing the user with flexibility in the use of pouch 236, i.e., when bag 112 is removed from support structure 114, pouch 236 can be attached to either support structure 114 or bag 112.

Pouch 236 can be used to hold a variety of objects such as yoga shoes or a yoga strap. It is particularly well-suited for use by a yoga instructor and can be used to transport a stack of papers, such as promotional flyers listing upcoming classes or events, as well as audio CDs and video DVDs that the instructor uses when conducting the class.

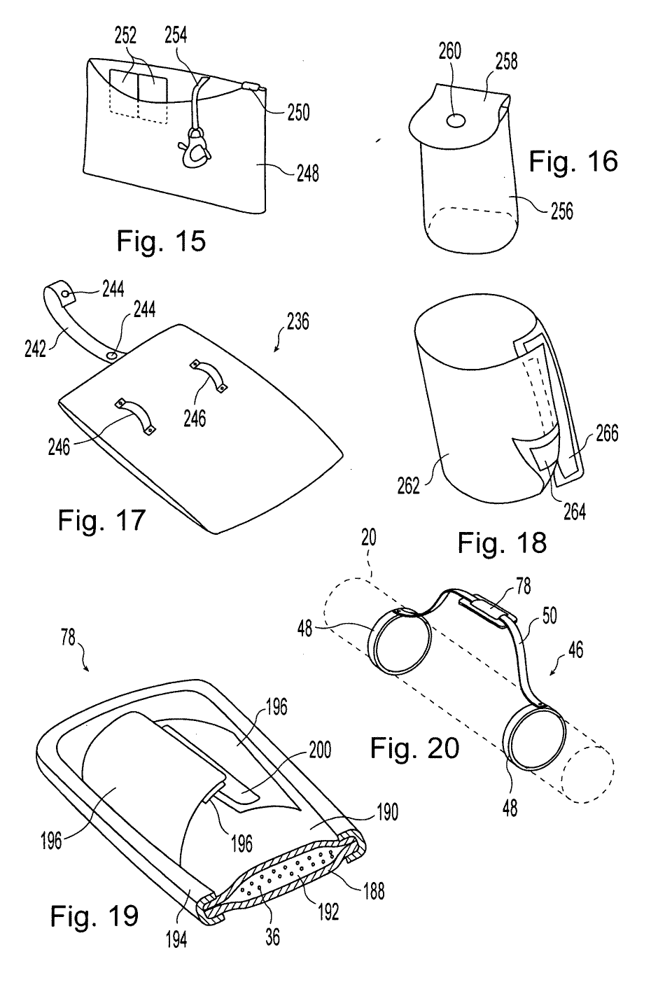

Bag 112 also includes an external pocket 248 that can be seen in both FIGS. 12 and 15. Pocket 248 has a zipper 250 for opening and closing pocket 248. Located within pocket 248 are two smaller pockets 252 which are sized to hold conventional ID cards such as a fitness facility membership card. A snap-ring suspended from strap 254 can be used to secure a key ring to bag 112 and can be positioned within pocket 248 or extended outwardly through zippered opening 250 as depicted in FIGS. 12 and 15.

Bag 112 can also includes a water bottle holder 256 opposite pocket 248. Bottle holder 256 is depicted in FIG. 16 and includes an upper flap 258. Flap 258 includes a central opening through which the top of a water bottle can project. Both bottle holder 256 and flap 256 are formed out of polyester fabric in the illustrated embodiment, however, other materials may also be used to form a water bottle holder on bag 112.

A fabric sleeve 262 is depicted in FIG. 18 and can be used to secure mat 20 in its rolled condition before placing mat 20 in bag 112. Hook 264 and loop 266 fasteners are used to secure sleeve 262 together about the rolled mat 20.

FIG. 20 illustrates another carrying device 46. Carrying device 46 has a very simple construction with two loops of material 48 through which the rolled mat 20 is inserted and a shoulder strap 50 that connect the two loops 48. Mats 20 can be provided with such devices 46 having loops 48 that are properly sized for mat 20. By using fixed length elastic bands to form loops 48, however, a single size loop 48 can fit a variety of mats having different diameters when rolled. Alternatively, loops 48 could be formed as straps having hook and loop fasteners, e.g., Velcro fasteners, that are used to secure the opposite ends of the strap together about a rolled mat 20 and thereby form loops 48 that are adjustable in size. It is also noted that while the illustrated example shows a fixed length strap 50 permanently affixed to loops 48, carrying device 46 could be easily adapted to include an adjustable shoulder strap similar to strap 72 used with carrier 52. A shoulder strap pad 78 having a gel-layer is shown mounted on carrying device 46 to enhance the comfort of carrying device 46.

While this invention has been described as having an exemplary design, the present invention may be further modified within the spirit and scope of this disclosure. This application is therefore intended to cover any variations, uses, or adaptations of the invention using its general principles.

What is claimed is:

1. A personal exercise mat comprising:
a top layer of material;
a bottom layer of material; and
a gel layer disposed between said top and bottom layers, said gel layer comprising a gel material and a plurality of microspheres.

2. The personal exercise mat of claim 1 wherein said plurality of microspheres are polyvinyl idine chloride microspheres.

3. The personal exercise mat of claim 1 wherein said mat has a length of at least about 92.2 cm, a width of at least about 30.7 cm, and a gel layer thickness within a range of about 0.32 cm to about 0.48 cm.

4. The personal exercise mat of claim 1 wherein said bottom layer comprises an exterior textured mesh skin neoprene layer.

5. The personal exercise mat of claim 4 wherein said top layer comprises a nylon layer exterior layer and an inner neoprene layer.

6. The personal exercise mat of claim 5 wherein said bottom layer has a thickness of approximately 0.2 cm and said top layer has a thickness within a range of about 0.2 cm to about 0.64 cm and said gel layer has a thickness within a range of about 0.32 cm to about 0.48 cm.

7. The personal exercise mat of claim 1 further comprising a material skirt attached to an outer perimeter of said mat, said material skirt being adapted to encircle an aerobic step bench and including an elastically stretchable portion whereby said material skirt is engageable with the aerobic step bench.

8. The personal exercise mat of claim 1 wherein said mat further includes a flap of material extending from an end of said mat, said flap including at least one reinforced aperture.

9. A personal exercise mat having
a top layer of material;
a bottom layer of material;
a gel layer disposed between said top and bottom layers; and
a security device permanently affixed to said mat.

10. The personal exercise mat of claim 9 wherein said security device includes a passive RFID tag.

11. The personal exercise mat of claim 10 wherein said mat further includes a flap of material extending from an end of said mat, said flap including at least one reinforced aperture.

12. The personal exercise mat of claim 10 wherein said security device is disposed between said top layer and said bottom layer.

13. The personal exercise mat of claim 10 wherein said top layer includes a nylon layer exterior layer and an inner neoprene layer; said bottom layer includes an exterior textured mesh skin neoprene layer; and said gel layer comprises a gel material and a plurality of resiliently compressible microspheres.

14. A personal exercise mat and carrier system comprising:
a plurality of combinations, each combination including:
(a) a personal exercise mat having a top and bottom surface; and
(b) a carrier, said carrier comprising:
first and second oppositely disposed flexible end panels;
a flexible bottom panel extending between and secured to said first and second end panels;
opposing flexible side panels extending between and secured to said first and second end panels, a substantial portion of each of said side panels being formed by a mesh material; said bottom panel being disposed between said side panels;
an upper flap, said flap being securable to said carrier with first and second substantially parallel zipper assemblies; and
wherein for each of said plurality of combinations the top surface of said personal exercise mat and said first and second zipper assemblies have a common color; and wherein said common colors of said plurality of combinations defines at least three separate colors.

15. The system of claim 14 wherein each of said combinations includes a shoulder strap and a shoulder strap pad attachable to said shoulder strap, said shoulder strap pad having a gel layer.

16. A personal exercise mat carrier, said carrier comprising:
a generally L-shaped support structure having a floor-engaging section and an upright section and at least one rotatable member disposed proximate a lower portion of said upright section, wherein said support structure is self-supporting with said upright section being disposed in a substantially vertical orientation and is supportable on said at least one rotatable member by tilting said upright section; and
a bag securable to said support structure, said bag defining an inner volume and having a partition member disposed within said inner volume, said bag further defining an opening providing access to said inner volume; and
a cap member repositionable between a closed position and an open position, said cap member covering said opening and inhibiting access to said inner volume when in said closed position and allowing access to said inner volume through said opening when in said open position; said cap member including a pouch adapted to hold a towel.

17. The carrier of claim 16 wherein said bag includes a mesh panel, said mesh panel promoting air flow between said inner volume and the ambient environment.

18. The carrier of claim 17 wherein said bag further comprises:
first and second stiffening members, said first stiffening member being disposed in said cap member and being positioned proximate an upper surface of said bag when said cap member is in said closed position, said second stiffening member being positioned opposite said first stiffening member when said cap member is in said closed position, said second stiffening member being positioned proximate said floor-engaging section when said bag is secured to said support structure; and
a foam insert engaged with said bag, said foam insert extending from a first position proximate said second stiffening member to a second position proximate said cap member and preventing collapse of said bag when said cap member is in said open position thereby enhancing access to said inner volume.

19. The carrier of claim 18 in combination with a personal exercise mat positionable in one of said at least two compartments when said cap member is in said closed position, said mat comprising:
a top layer of material;
a bottom layer of material; and
a gel layer disposed between said top and bottom layers.

20. The carrier of claim 18 wherein said pouch includes a zippered opening, said zippered opening disposed within said inner volume when said cap member is in said closed position; and wherein said carrier further comprises:
an exterior detachable pouch, said detachable pouch including a mesh panel promoting air flow between an interior and exterior of said detachable pouch and wherein said detachable pouch is selectively attachable to said support structure and said bag.
